(19) United States
(12) Patent Application Publication
(10) Pub. No.: US 2025/0115041 A1
(43) Pub. Date: Apr. 10, 2025

(54) SYSTEMS AND METHODS FOR MANUFACTURING LARGE-SIZED SANDWICH PANEL

(71) Applicant: Good RV Equipment INC, Marysville, WA (US)

(72) Inventors: Yanfeng Cui, Marysville, WA (US); Kelly Zuoer Cui, Marysville, WA (US)

(21) Appl. No.: 18/483,012

(22) Filed: Oct. 9, 2023

(51) Int. Cl. B32B 38/00; B21B 1/22; B32B 7/12; B32B 15/082; B32B 15/092; B32B 15/20; B32B 38/16; B62D 63/06

(52) U.S. Cl. CPC B32B 38/0012; B21B 1/22; B32B 7/12; B32B 15/082; B32B 15/092; B32B 15/20; B32B 38/162; B32B 2250/40; B62D 63/06

(57) ABSTRACT

Methods and systems for manufacturing large sized sandwich panels are provided. In some embodiments, the method includes (1) positioning a bottom flat portion or a rolled material on a bottom large sized mold; (2) applying a first sealant in a first predetermined pattern on an upper surface of the bottom flat portion; (3) positioning an insulation layer on the upper surface of the bottom flat portion; (4) applying a second sealant in a second predetermined pattern on an upper side of the insulation layer; (5) positioning a upper flat portion on the upper side of the insulation layer; (6) pressing the upper flat portion, by an upper large sized mold, against the insulation layer and the bottom flat portion under a predetermined temperature profile during a predetermined time period.

### TECHNICAL FIELD

The present disclosure relates to systems and methods for manufacturing large sized metal panels. More particularly, systems and methods for manufacturing large sized sandwich aluminum panels for industrial uses, such as stackable trailer systems or modular container home systems. These stackable/modular systems can be conveniently disassembled, folded, and stacked in a shipping container.

### BACKGROUND

Multi-layer panels can be used to manufacture various items. Traditional multi-layer panels do not perform well in terms of structural rigidity and insulation. Traditional panels usually have a relatively small size, e.g., smaller than 5 feet by 5 feet. It is partly because traditional manufacturing methods cannot create larger panels with desirable characteristics in a cost-effective way. Therefore, it is advantageous to have an improved system to address the foregoing need.

### SUMMARY

The present disclosure provides methods for manufacturing large sized sandwich (or sandwiched) panels with suitable structural rigidity and desirable characteristics such as thermally insulated.

The present methods include two stages: (A) a roll-material preparation stage and (B) an assembling/heating/pressing stage. In the first stage (roll-material preparation), in some embodiments, the present methods includes (1) positioning a rolled material in a roll-material preparation module; (2) unrolling the rolled material partially so as to form a flat portion of the rolled material; (3) processing at least one surfaces of the flat portion of the rolled material; (4) rolling the flat portion to form a processed rolled material.

In the second stage (assembling/heating/pressing), the present method includes (i) unrolling and cutting the processed rolled material to form a bottom flat position; (ii) positioning the bottom flat portion on a bottom large sized mold; (iii) applying a first sealant in a first predetermined pattern on an upper surface of the bottom flat portion; (iv) positioning an insulation layer on the upper surface of the bottom flat portion; (v) applying a second sealant in a second predetermined pattern on an upper side of the insulation layer; (vi) unrolling and cutting the processed rolled material to form an upper flat portion; (vii) positioning the upper flat portion on the upper side of the insulation layer; (viii) pressing the upper flat portion, by an upper large sized mold, against the insulation layer and the bottom flat portion under a predetermined temperature profile during a predetermined time period; and (ix) forming a large-sized sandwich panel by the upper flat portion, the insulation layer and the bottom flat portion. The first sealant and the second sealant provide structural support to the large sized sandwich panel.

In some embodiments, the first and second predetermined patterns can be dispensed on corresponding recesses/trenches formed on the insulation layer. Forming these recesses/trenches on the insulation layer enables flowability of the dispensed sealant such that the sealant patterns can be formed at desirable locations as planned.

In some embodiments, additives can be added to the sealants/adhesives so as to enhance their structural strength. For example, the additives can be metal powders, plastic particles, suitable chemicals, etc.

In some embodiments, the dimension of the large-sized sandwich is around 40 feet×10 feet×2 inches. In some embodiments, the large-sized sandwich panel can be used to manufacture statable trailers that can be stored in a shipping container. Embodiments of the statable trailers are discussed below with reference to FIGS. 6-7B.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1A is a block diagram showing a system for manufacturing large sized sandwich panels in accordance with one or more implementations of the present disclosure.

FIG. 1B is a schematic side view illustrating processes of forming a large sized sandwich panel in accordance with one or more implementations of the present disclosure.

FIG. 1C is a schematic side view illustrating a large sized sandwich panel in accordance with one or more implementations of the present disclosure.

FIGS. 2A-2D are schematic view illustrating sealant patterns of the large sized sandwich panels in accordance with one or more implementations of the present disclosure.

FIG. 3 is a block diagram illustrating an overview of devices on which some implementations can operate.

FIG. 4 is a flowchart of a method in accordance with one or more implementations of the present disclosure.

FIG. 5 is a flowchart of a method in accordance with one or more implementations of the present disclosure.

FIG. 6 is a schematic view illustrating a trailer system in accordance with one or more implementations of the present disclosure.

FIGS. 7A and 7B are schematic views illustrating a stackable trailer system in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

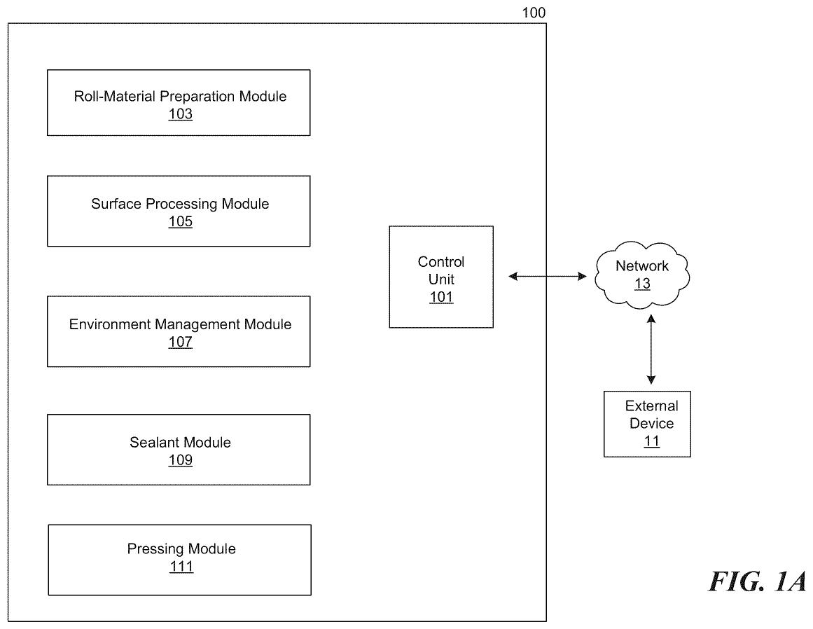

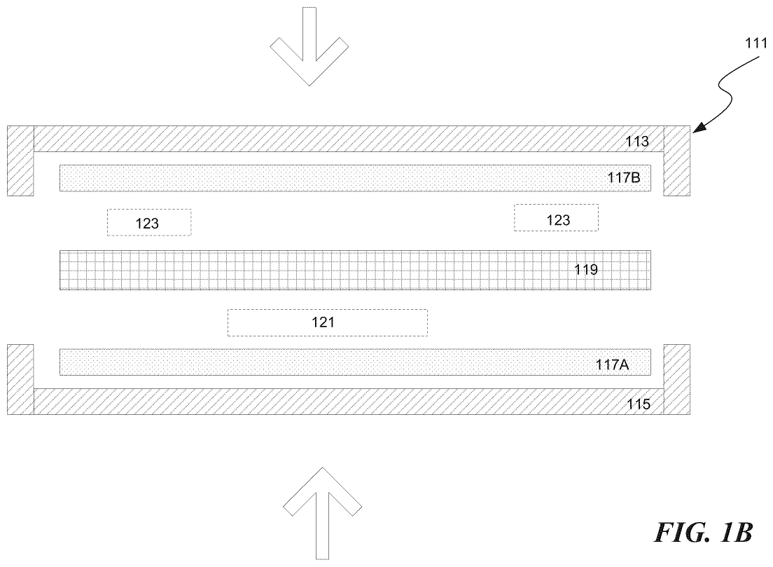

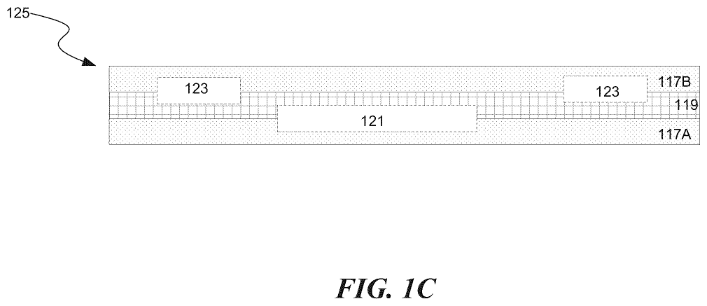

FIG. 1A is a block diagram showing a system 100 for manufacturing large sized sandwich panels in accordance with one or more implementations of the present disclosure. The system 100 includes a control unit 101, a roll-material preparation module 103, a surface processing module 105, an environment management module 107, a sealant module 109, and a pressing module 111. The control unit 101 is configured to communicate with and control other components of the system 100.

The control unit 101 is also configured to communicate with an external device 11 (e.g., a smartphone, a portable device, a server, a personal computer, etc.) via a network 105. In some embodiments, the network 13 can include Internet, a local network, any other suitable near field communication networks, etc. In some embodiments, an operator can manage the system 100 (e.g., providing operational instructions/parameters, adjusting manufacturing processes, etc.) via the external device 11 through the network 13.

The roll-material preparation module 103 is configured to prepare a rolled material (e.g., a rolled sheet material such as an aluminum sheet roll) for further process. In some embodiments, the roll-material preparation module 103 can unroll the rolled material to form a flat portion for some treatments/processes (e.g., a surface treatment or cleaning by the surface processing module 103). Once the flat portion is processed, the roll-material preparation module 101 can roll the processed flat portion to form a processed rolled material for further processes (e.g., to form a sandwich panel by the pressing module 111). In some embodiments, the roll-material preparation module 103 can include a motor, a belt, a guiding rail, a roller, any other suitable components to move/position the rolled material etc.

In some embodiments, the roll-material preparation module 103 can also include a flipping module configured to turn a cut flat portion during processes. For example, the flipping module can include multiple handing arm with suction components (e.g., cups) to temporally attach to the flat portion so as to move/turn the same.

The surface processing module 105 is configured to clean and/or provide treatments/paints/coatings to one or more surface of the flat portion of the rolled material. For example, the surface processing module 105 can apply chemical cleaning agents (e.g., hypochlorite, bleach, alcohols, chlorine dioxide, hydrogen peroxide, peracetic acid, iodophor disinfectant, quaternary ammonium compounds, etc.) on the one or more surface of the flat portion to remove dust, oil, other desirable particles, etc. The surface processing module 105 can also apply surface treatment materials to the one or more surface of the flat portion so as to protect or enhance characteristics (e.g., suitable for further processes; smoothness; elasticity, suitable for adhesives/sealants etc.). In some embodiments, the surface treatment materials includes epoxy, Polyvinylidene Fluoride or Polyvinylidene Difluoride (PVF2 or PVDF) paints or primers, etc.

In some embodiments, the surface processing module 105 can provide two surfaces of the flat portion with different treatments. For example, an inner surface (i.e., when rolled, the surface facing the center of the material roll) of the flat portion can be treated with PVDF paint and PVDF primer, whereas an outer surface (i.e., when rolled, the surface away from to the center of the material roll) can be treated with epoxy.

In some embodiments, the surface processing module 105 can be configured to perform an oxidation surface treatment process on surfaces of the flat portion so as to prevent the flat portion from erosion and thus increase its durability. In some embodiments, the surface processing module 105 can coordinate with the environment management module 107 to heat the flat portion. For example, the flat portion can be heated to around 240 degrees Celsius for around 180 seconds. In some embodiments, the surface processing module 105 can apply a film on the flat portion after the foregoing treatments so as to enhance protection. Once the flat portion is processed, the surface processing module 105 can roll the flat portion to form a processed rolled material for further processes.

In some embodiments, the surface processing module 105 can coat a nano-material layer to the first portion so as to adjust its surface characteristics. The nano-material layer can include a nano material such as carbon-based nano materials (e.g., carbon nanotubes and carbon nanofiber), metal-based nano materials, dendrimers and composites.

The environment management module 107 is configured to control and management environmental factors such as temperature, humidity, air quality, air pressure etc. during the processes discussed herein. For example, as discussed above, the environment management module 107 can coordinate with the surface processing module 105 during surface treatment processes. Similarly, the environment management module 107 can also work with (i) the sealant module 109 during seal dispensing processes (e.g., 40-50 degrees Celsius) and (ii) the pressing module 111 during pressing processes (e.g., to form a sandwich panel)(e.g., 40-50 degrees Celsius for 4 hours).

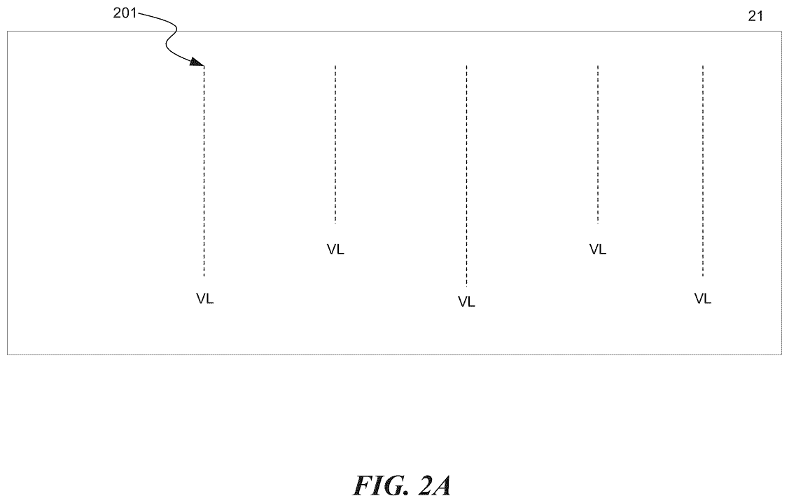

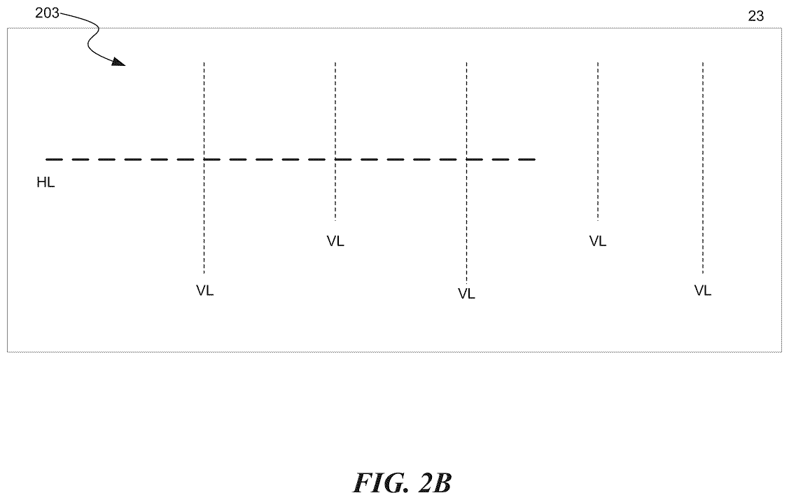

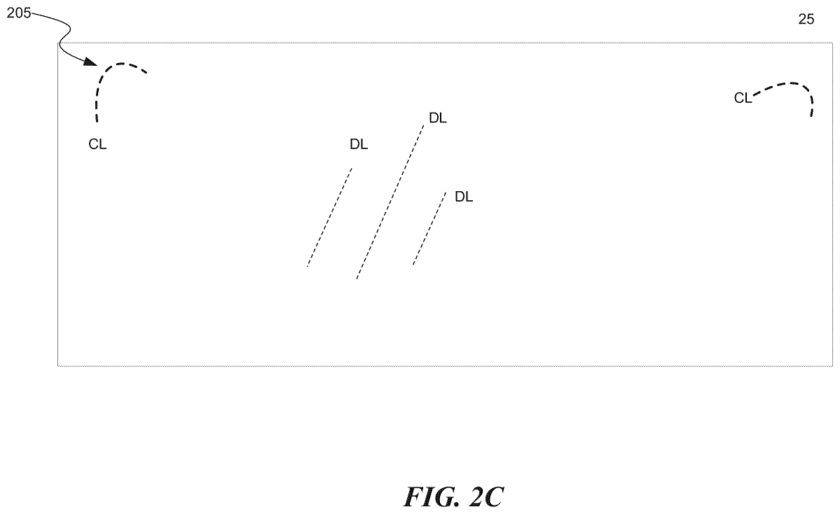

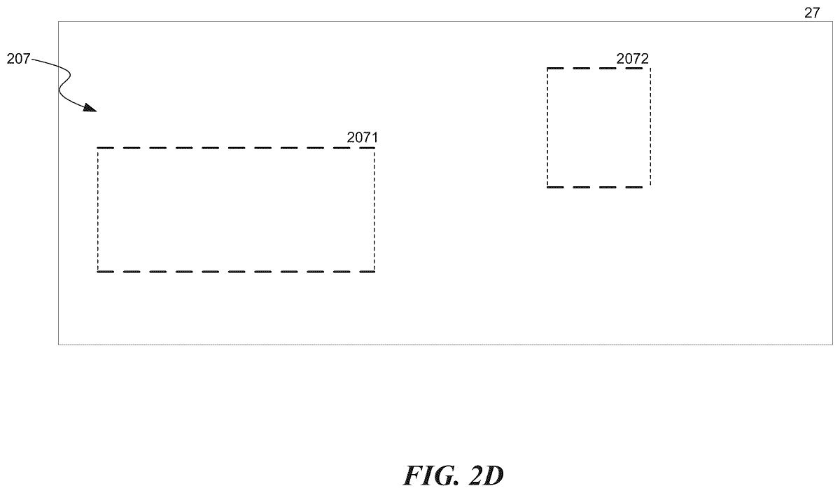

The sealant module 109 is configured to apply (e.g., dispense) sealants or adhesives on surfaces of the flat portion or the rolled material, as well as surfaces of other layers such as an insulation layer. In some example, the insulation layer can be positioned between two cut, processed flat portions when forming a sandwich panel. In some embodiments, the insulation layer can include materials such as Expanded Polystyrene (XPS), foams, fiberglass, rock and slag wool, cellulose, natural fibers, other suitable insulation materials, etc. In some embodiments, the sealants/adhesives can include two-component solvent-free polyurethane (PU) adhesives, sealants including a resin/hardener such as polyols and poly-isocyanate polymers, etc. The insulation layer can be coupled with two cut/processed flat portions of the rolled material by these adhesives and sealants. These adhesives and sealants can be formed in patterns so as to provide structural rigidity and support to the sandwich panel to be formed. Embodiments of the sealant patterns are discussed in detail with reference to FIGS. 2A-2D.

The pressing module 111 is configured to press the two cut/processed flat portions of the rolled material and the insulation layer to form a sandwich panel. Referring to FIG. 1B, the pressing module 111 includes an upper mold 113 and a bottom mold 115. Two cut/processed flat portions (bottom flat portion 117A; upper flat portion 117B) and an insulation layer 119 can first be positioned on the bottom mold. As shown in FIG. 1B, a first sealant pattern 121 is located between the bottom flat portion 117A and the insulation layer 119. A second sealant pattern 123 is located between the upper flat portion 117B and the insulation layer 119. In the illustrated embodiments, the first sealant pattern 121 and the second sealant pattern 123 are misaligned. In some embodiments, the first sealant pattern 121 and the second sealant pattern 123 can be aligned (e.g., vertically) in various designs.

The upper mold 113 can then move toward the bottom mold 115 and keeps pressing the same. In some embodiments, the foregoing pressing process can last 3-5 hours while the operating temperature is maintained at 40-50 degrees Celsius. As shown in FIG. 1C, a large sized sandwich panel 125 is formed. The first sealant pattern 121 and the second sealant pattern 123 are configured to provide structural rigidity and support to the sandwich panel 125.

FIGS. 2A-2D are schematic view illustrating sealant patterns of the large sized sandwich panels in accordance with one or more implementations of the present disclosure. In FIG. 2A, a sealant pattern 201 can be formed on a flat portion 21 (or an insulation layer). As shown, the sealant pattern 201 includes multiple vertical lines VL formed by dispensed sealants/adhesives. In the illustrated embodiments, these lines are generally in parallel. In other embodiments, the lines can be tiled and do not need to be in parallel. In the illustrated embodiments, the lengths of these lines are different. In some embodiments, the lengths of the lines can be generally the same.

In FIG. 2B, a sealant pattern 203 can be formed on a flat portion 23 (or an insulation layer). As shown, the sealant pattern 203 includes multiple vertical lines VL and a horizontal line HL formed by dispensed sealants/adhesives. In the illustrated embodiments, the horizontal line HL and the vertical lines VL are generally perpendicular to each other. In other embodiments, the horizontal line HL and the vertical lines VL can have different arrangements depending on various design needs.

In FIG. 2C, a sealant pattern 205 can be formed on a flat portion 25 (or an insulation layer). As shown, the sealant pattern 205 includes multiple diagonal lines DL and curve lines CL formed by dispensed sealants/adhesives. In the illustrated embodiments, the diagonal lines DL are generally perpendicular to each other. In other embodiments, the diagonal lines DL can have different arrangements depending on various design needs. As also shown, the curve lines CL can be formed at the corners of the flat portion 25 to enhance structural rigidity. In other embodiments, the curve lines CL can have different arrangements depending on various design needs.

In FIG. 2D, a sealant pattern 207 can be formed on a flat portion 27 (or an insulation layer). As shown, the sealant pattern 207 includes multiple sub-patterns 2071, 2072 formed by dispensed sealants/adhesives. In the illustrated embodiments, the sub-patterns 2071 and 2072 are determined based on a future design of the flat portion 27. For example, the sub-patterns 2071, 2072 are in accordance with openings to be formed on the flat portion 27. By this arrangement, the sub-patterns 2071, 2072 can provide structural rigidity to flat portion 27 once the openings are formed.

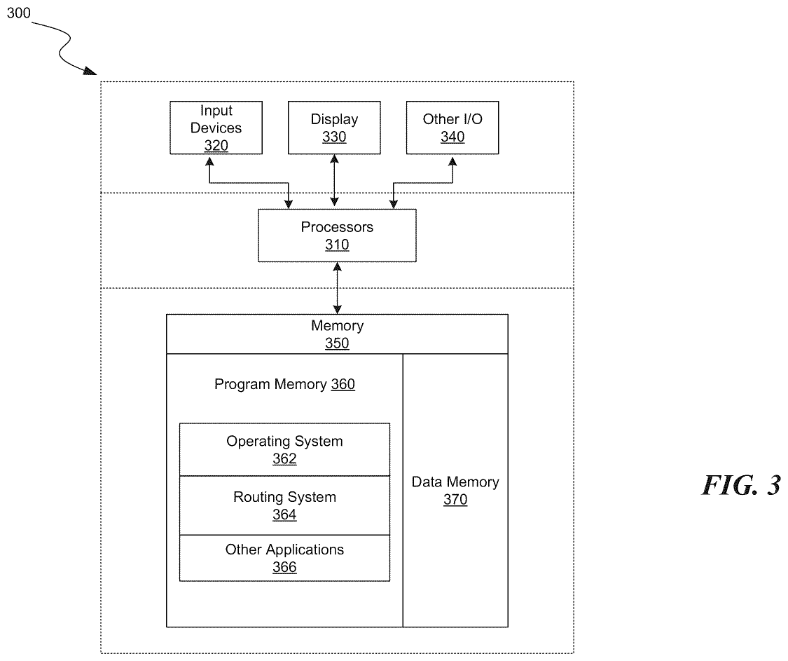

FIG. 3 is a block diagram illustrating an overview of devices (e.g., the external device 11, the control unit 101, a server etc.) on which some implementations can operate. Device 300 can include one or more input devices 320 that provide input to the processor(s) 310 (e.g., CPU(s), GPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. Processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, the display 330 provides graphical and textual visual feedback to a user. In some implementations, the display 330 includes the input device as part of the display, such as when the input device is a touchscreen or is equipped with an eye direction monitoring system. In some implementations, the display is separate from the input device. Examples of display devices include an LCD display screen, an LED display screen, a projected, holographic, or augmented reality display (such as a heads-up display device or a head-mounted device), and so on. Other I/O devices 340 can also be coupled to the processor, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. The device 300 can utilize the communication device to distribute operations across multiple network devices.

The processors 310 can have access to a memory 350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, routing system 364 (e.g., for implementing the routing plan discussed herein), and other application programs 366. The memory 350 can also include data memory 370, user interface data, event data, image data, biometric data, sensor data, device data, location data, network learning data, application data, alert data, structural data, camera data, retrieval data, management data, notification data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

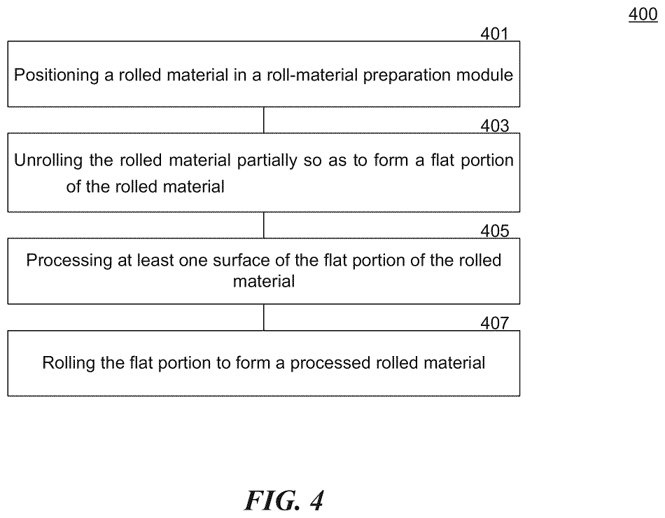

FIG. 4 is a flowchart of a method for preparing rolled materials in accordance with one or more implementations of the present disclosure. The method 400 includes, at block 401, positioning a rolled material in a roll-material preparation module. At block 403, the method 400 continues by unrolling the rolled material partially so as to form a flat portion of the rolled material. At block 405, the method 400 continues by processing at least one surface of the flat portion of the rolled material. At block 407, the method 400 continues by rolling the flat portion to form a processed rolled material.

In some embodiments, the method 400 further comprises positioning the flat portion of the rolled material on a bottom mold (e.g., the bottom mold 115 discussed in FIG. 1B). In some embodiments, the method 400 further comprises cleaning the at least one surface of the flat portion of the rolled material by a chemical agent. In some embodiments, the method 400 further comprises removing undesirable particle from the at least one surface of the flat portion of the rolled material.

In some embodiments, the method 400 further comprises forming a layer on the at least one surface of the flat portion of the rolled material. In some embodiments, the layer includes epoxy. In some embodiments, the layer can include Polyvinylidene Fluoride or Polyvinylidene Difluoride. In some embodiments, the layer can be an oxidation layer.

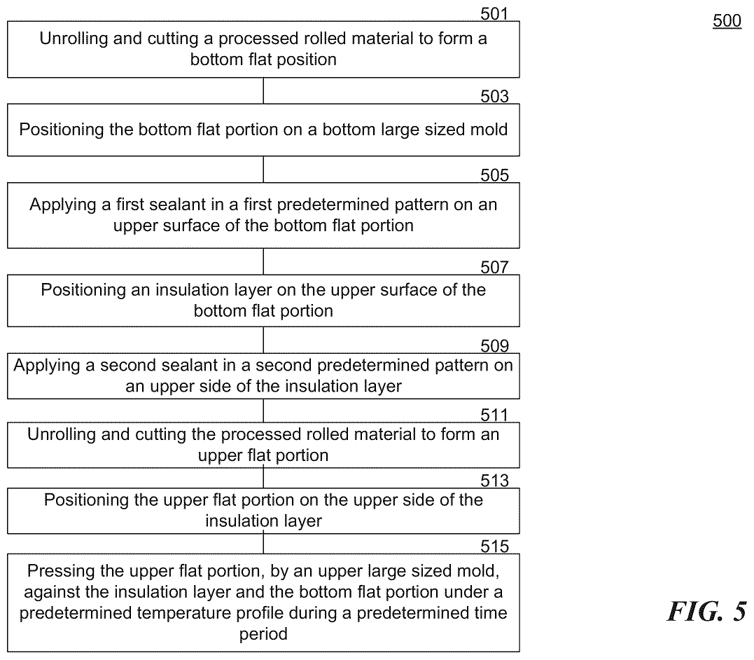

FIG. 5 is a flowchart of a method 500 for manufacturing a large sized sandwich panel. The method 500 includes, at block 501, unrolling and cutting a processed rolled material to form a bottom flat position. The method 500 includes, at block 503, positioning the bottom flat portion on a bottom large sized mold.

The method 500 includes, at block 505, applying a first sealant in a first predetermined pattern on an upper surface of the bottom flat portion. The method 500 includes, at block 507, positioning an insulation layer on the upper surface of the bottom flat portion. The method 500 includes, at block 509, applying a second sealant in a second predetermined pattern on an upper side of the insulation layer.

The method 500 includes, at block 511, unrolling and cutting the processed rolled material to form an upper flat portion. The method 500 includes, at block 513, positioning the upper flat portion on the upper side of the insulation layer. The method 500 includes, at block 515, pressing the upper flat portion, by an upper large sized mold, against the insulation layer and the bottom flat portion under a predetermined temperature profile during a predetermined time period. The method 500 then includes forming a large-sized sandwich panel by the upper flat portion, the insulation layer and the bottom flat portion, and the first sealant and the second sealant provide structural support to the large sized sandwich panel.

In some embodiments, the processed rolled material includes an aluminum layer, an epoxy, and a Polyvinylidene Difluoride layer. In some embodiments, the large-sized sandwich panel has a dimension of 40 feet×10 feet×2 inches. In some embodiments, the first sealant and the second sealant include a two-component solvent-free polyurethane (PU) adhesive.

In some embodiments, the predetermined temperature profile includes a temperate range from 40 degrees Celsius to 50 degrees Celsius. In some embodiments, the predetermined time period ranges from 3 hours to 5 hours.

In some embodiments the first predetermined pattern can be vertically aligned with the second predetermined pattern. In some embodiments, the first/second predetermined pattern can include sealant lines in parallel with one another. In some embodiments, the first/second predetermined pattern includes sealant lines perpendicular to one another. In some embodiments, the first predetermined pattern includes curved sealant lines.

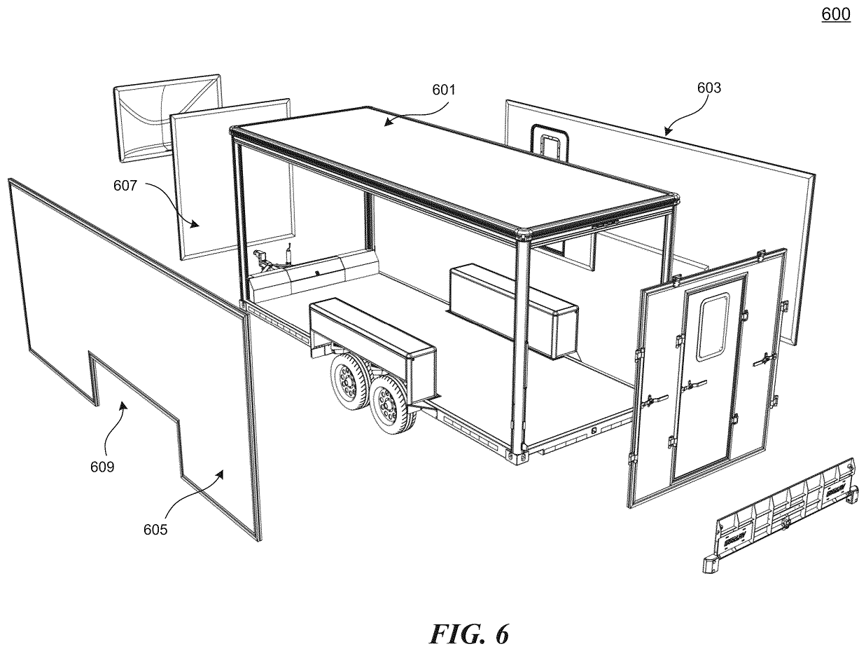

FIG. 6 is a schematic view illustrating a trailer system 600 in accordance with one or more implementations of the present disclosure. The trailer system 600 can be made of large sized sandwich panels 601, 603, and 605 discussed herein (e.g., 40 feet×10 feet×2 inches). The sandwich panels can be made in different sizes, such as a side panel 607 (e.g., 10 feet×10 feet×2 inches).

As shown in FIG. 6, the panel 605 is formed an opening 609. When the panel 605 is manufactured, one or more sealant patterns (e.g., the first sealant pattern 121 and the second sealant pattern 123 in FIG. 1B) can be formed in accordance with the opening 609 so as to enhance structural rigidity of the panel 605.

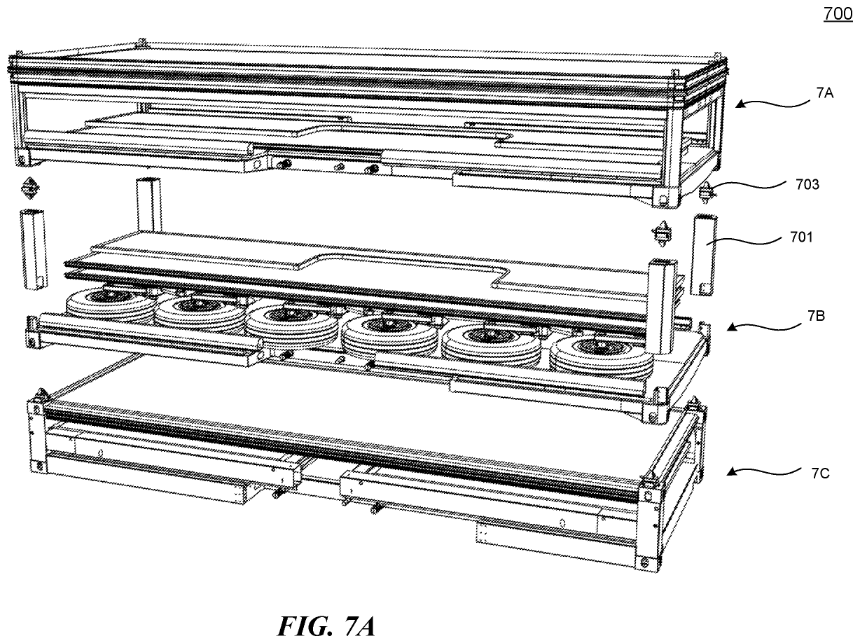

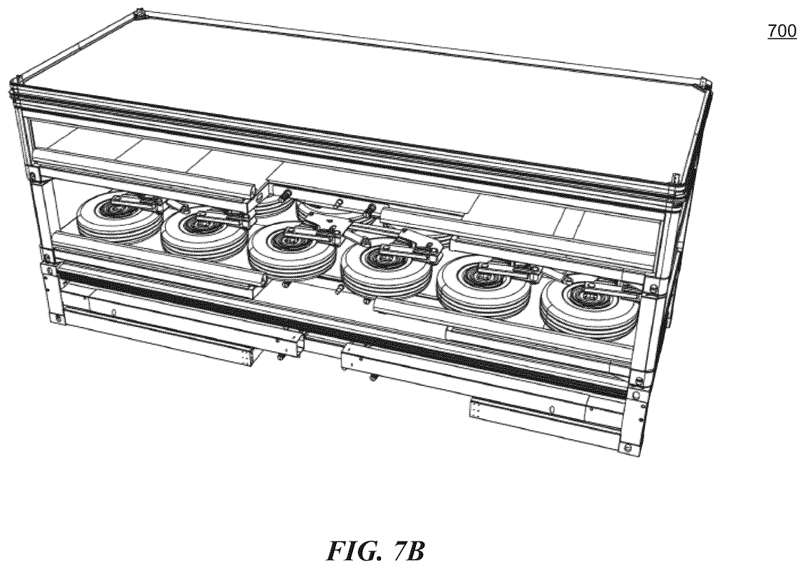

FIGS. 7A and 7B are schematic views illustrating a stackable trailer system 700 in accordance with one or more implementations of the present disclosure. In the Illustrated embodiments of FIG. 7A, a stacked trailer set 700 includes multiple (e.g., three) individual trailer systems and is sized to fit in a shipping container. As shown, the stacked trailer set 700 includes a first trailer system 7A, a second trailer system 7B, and a third trailer system 7C. The trailer systems 7A-C are stacked via multiple lower portions 701 of corner modules and multiple insert connectors 703. In the illustrated embodiments, the first trailer system 7A and the second trailer system 7B are of the same type. The third trailer system 7C can be another type (e.g., having a platform structure. In FIG. 7B, the stacked trailer set 700 are stacked and the components (wheels, panels, etc.) of the first/second/third trailer systems 7A-C can be stored space-efficiently. By this configuration, the stacked trailer set 700 is convenient, easy to be transported and is ready to be shipped by a shipping container.

### Additional Considerations

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method comprising:
positioning a rolled material in a roll-material preparation module;
unrolling the rolled material partially so as to form a flat portion of the rolled material;
processing at least one surface of the flat portion of the rolled material; and
rolling the flat portion to form a processed rolled material.

2. The method of claim 1, further comprising positioning the flat portion of the rolled material on a bottom mold.

3. The method of claim 1, further comprising cleaning the at least one surface of the flat portion of the rolled material by a chemical agent.

4. The method of claim 1, further comprising removing undesirable particle from the at least one surface of the flat portion of the rolled material.

5. The method of claim 1, further comprising forming a layer on the at least one surface of the flat portion of the rolled material.

6. The method of claim 5, wherein the layer includes epoxy.

7. The method of claim 5, wherein the layer includes Polyvinylidene Fluoride or Polyvinylidene Difluoride.

8. The method of claim 5, wherein the layer includes an oxidation layer.

9. A method comprising:
unrolling and cutting a processed rolled material to form a bottom flat position;
positioning the bottom flat portion on a bottom large sized mold;
applying a first sealant in a first predetermined pattern on an upper surface of the bottom flat portion;
positioning an insulation layer on the upper surface of the bottom flat portion;
applying a second sealant in a second predetermined pattern on an upper side of the insulation layer;
unrolling and cutting the processed rolled material to form an upper flat portion;
positioning the upper flat portion on the upper side of the insulation layer;
pressing the upper flat portion, by an upper large sized mold, against the insulation layer and the bottom flat portion under a predetermined temperature profile during a predetermined time period; and
forming a large-sized sandwich panel by the upper flat portion, the insulation layer and the bottom flat portion, wherein the first sealant and the second sealant provide structural support to the large sized sandwich panel.

10. The method of claim 9, wherein the processed rolled material includes an aluminum layer, an epoxy, and a Polyvinylidene Difluoride layer.

11. The method of claim 9, wherein the large-sized sandwich panel has a dimension of 40 feet×10 feet×2 inches.

12. The method of claim 9, wherein the first sealant and the second sealant include a two-component solvent-free polyurethane (PU) adhesive.

13. The method of claim 9, wherein the predetermined temperature profile includes a temperate range from 40 degrees Celsius to 50 degrees Celsius.

14. The method of claim 9, wherein the predetermined time period ranges from 3 hours to 5 hours

15. The method of claim 9, wherein the first predetermined pattern is vertically aligned with the second predetermined pattern

16. The method of claim 9, wherein the first predetermined pattern includes sealant lines in parallel with one another.

18. The method of claim 9, wherein the first predetermined pattern includes sealant lines perpendicular to one another.

19. The method of claim 9, wherein the first predetermined pattern includes curved sealant lines.

20. A method, comprising:
positioning a rolled material in a roll-material preparation module;
unrolling the rolled material partially so as to form a flat portion of the rolled material;
processing at least one surface of the flat portion of the rolled material;
rolling the flat portion to form a processed rolled material;
unrolling and cutting the processed rolled material to form a bottom flat position;
positioning the bottom flat portion on a bottom large sized mold;
applying a first sealant in a first predetermined pattern on an upper surface of the bottom flat portion;
positioning an insulation layer on the upper surface of the bottom flat portion;
applying a second sealant in a second predetermined pattern on an upper side of the insulation layer;
unrolling and cutting the processed rolled material to form an upper flat portion;
positioning the upper flat portion on the upper side of the insulation layer;
pressing the upper flat portion, by an upper large sized mold, against the insulation layer and the bottom flat portion under a predetermined temperature profile during a predetermined time period; and
forming a large-sized sandwich panel by the upper flat portion, the insulation layer and the bottom flat portion, wherein the first sealant and the second sealant provide structural support to the large sized sandwich panel.
